(19) United States
(12) Patent Application Publication
(10) Pub. No.: US 2023/0002917 A1
(43) Pub. Date: Jan. 5, 2023

(54) AMMONIA PRODUCTION METHOD AND AMMONIA PRODUCTION APPARATUS

(71) Applicants: THE UNIVERSITY OF TOKYO, Tokyo (JP); NISSAN CHEMICAL CORPORATION, Tokyo (JP)

(72) Inventors: Yoshiaki NISHIBAYASHI, Tokyo (JP); Kazuya ARASHIBA, Tokyo (JP); Yuya ASHIDA, Tokyo (JP); Shoichi KONDO, Funabashi (JP); Takamasa KIKUCHI, Funabashi (JP)

(73) Assignees: THE UNIVERSITY OF TOKYO, Tokyo (JP); NISSAN CHEMICAL CORPORATION, Tokyo (JP)

(21) Appl. No.: 17/640,457

(22) PCT Filed: Sep. 4, 2020
(86) PCT No.: PCT/JP2020/033649

§ 371 Date: Sep. 12, 2022

(30) Foreign Application Priority Data
Sep. 5, 2019 (JP) 2019-162176

(51) Int. Cl. C25B 1/27; C25B 1/50; C25B 9/23; C25B 15/08; C25B 11/095; B01J 31/22

(52) U.S. Cl. CPC C25B 1/27; C25B 1/50; C25B 9/23; C25B 15/08; C25B 11/095; B01J 31/2295; B01J 2231/62

(57) ABSTRACT

An ammonia production method is a method of producing ammonia from nitrogen molecule using electron supplied from a power supply in the presence of a complex and a proton source. The complex used is, for example, a molybdenum complex (1) that is carried on Merrifield resin. The proton source used is an electrolyte membrane, a solution used in a cathode tank, or both the electrolyte membrane and the solution used in the cathode tank:

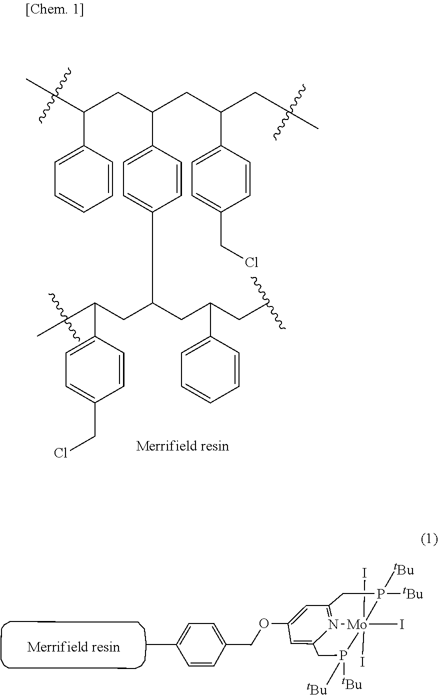

### TECHNICAL FIELD

The present disclosure relates to an ammonia production method and an ammonia production apparatus.

### BACKGROUND ART

With regard to a method of producing ammonia from nitrogen molecule, there has been a report using samarium (II) iodide as a reducing agent and using an alcohol group or water as a proton source when a molybdenum complex is used as a catalyst (Non-Patent Literature 1). It has also been reported that ammonia is produced by using a molybdenum complex supported on a polystyrene resin (Non-Patent Literature 2).

### CITATION LIST

### Non-Patent Literature

Non-Patent Literature 1: Nature, 2019, Vol. 568 (7753), pp 536-540; and Non-Patent Literature 2: Chem. Lett. 2019, Vol. 48, pp. 693-695

### SUMMARY

### Technical Problem

With regard to the method of producing ammonia from nitrogen molecule, in the case where the molybdenum complex is used as the catalyst, from the viewpoint of supplying electron to the reaction system, there is a need for using samarium (II) iodide as the reducing agent in Non-Patent Literature 1, and there is a need for using decamethylcobaltocene as the reducing agent in Non-Patent Literature 2. From a practical point of view, there is a problem that collection and recycle of these reducing agents are not easy.

In order to solve the problem described above, a main object of the present disclosure is to provide a method of electrochemically producing ammonia without using a reducing agent.

### Solution to Problem

In order to achieve the object described above, the inventors have manufactured an ammonia production apparatus where a molybdenum complex is placed in the vicinity of an electrode with a view to promptly supplying electron and proton required for production of ammonia from nitrogen molecule to the molybdenum complex, have found that ammonia is producible by using electron supplied from a power supply without using samarium (II), decamethylcobaltocene or the like as the reducing agent, and have completed the present disclosure. With regard to the method of producing ammonia from nitrogen molecule, there has been no report producing ammonia by using electron supplied from a power supply, with using a molybdenum complex as a catalyst but without using a reducing agent.

According to one aspect of the present disclosure, there is provided an ammonia production method of producing ammonia from nitrogen molecule using electron supplied from a power supply in presence of a complex and a proton source,

wherein the complex is:

(A) a molybdenum complex having 2,6-bis(dialkylphosphinomethyl)pyridine (where two alkyl groups are identical with each other or are different from each other; and at least one hydrogen atom on a pyridine ring is substituted with or is not substituted with an alkyl group, an alkoxy group or a halogen atom), as a PNP ligand;

(B) a molybdenum complex having 1,3-bis(dialkylphosphinomethyl)benzoimidazol-2-ylidene(where two alkyl groups are identical with each other or are different from each other; and at least one hydrogen atom on a benzene ring is substituted with or is not substituted with an alkyl group, an alkoxy group or a halogen atom), as a PCP ligand;

(C) a molybdenum complex having bis(dialkylphosphinoethyl)arylphosphine (where two alkyl groups are identical with each other or are different from each other) as a PPP ligand; or

(D) a molybdenum complex expressed as trans-Mo (N₂)₂ (R⁵R⁶R⁷P)₄ (where R⁵ and R⁶ represent aryl groups that are identical with each other or are different from each other; R⁷ represents an alkyl group; and two R⁷ groups are connected with each other to form an alkylene chain or are not connected with each other), and

the proton source used is an electrolyte membrane, a solution used in a cathode tank, or both the electrolyte membrane and the solution used in the cathode tank.

According to one aspect of the present disclosure, there is provided an ammonia production apparatus, comprising: an apparatus main body comprising a membrane electrode assembly configured such that an ion exchange membrane is placed between a cathode and an anode; a pair of current collectors arranged to place the membrane electrode assembly therebetween; an anode tank placed on one current collector side that is in contact with the anode; a cathode tank placed on other current collector side that is in contact with the cathode; and a nitrogen gas supplier configured to supply nitrogen gas to the cathode tank; and a power supply device placed outside of the apparatus main body and connected with the pair of current collectors, wherein the cathode includes, as a catalyst,

(A) a molybdenum complex having 2,6-bis(dialkylphosphinomethyl)pyridine (where two alkyl groups are identical with each other or are different from each other; and at least one hydrogen atom on a pyridine ring is substituted with or is not substituted with an alkyl group, an alkoxy group or a halogen atom), as a PNP ligand;

(B) a molybdenum complex having 1,3-bis(dialkylphosphinomethyl)benzoimidazol-2-ylidene (where two alkyl groups are identical with each other or are different from each other; and at least one hydrogen atom on a benzene ring is substituted with or is not substituted with an alkyl group, an alkoxy group or a halogen atom), as a PCP ligand;

(C) a molybdenum complex having bis(dialkylphosphinoethyl) arylphosphine (where two alkyl groups are identical with each other or are different from each other) as a PPP ligand; or

(D) a molybdenum complex expressed as trans-Mo (N₂)₂ (R⁵R⁶R⁷P)₄ (where R⁵ and R⁶ represent aryl groups that are identical with each other or are different from each other; R⁷ represents an alkyl group; and two R⁷ groups are connected with each other to form an alkylene chain or are not connected with each other), and

the anode includes a catalyst acting to produce proton from water.

### Advantageous Effects of Invention

The ammonia production method according to the aspect of the present disclosure enables ammonia to be easily produced from the nitrogen molecule using electron supplied from the power supply in the presence of the molybdenum complex and the ion exchange membrane, without using any reducing agent. The ammonia production apparatus according to the aspect of the present disclosure produces proton from water in the anode tank by the action of the catalyst included in the anode. The proton moves through the anode and the ion exchange membrane to the cathode. In the cathode tank, the proton moved, the nitrogen gas supplied to the cathode tank, and the electron supplied from the power supply device to the cathode react with one another by the action of the molybdenum complex included in the cathode to produce ammonia. The ammonia production apparatus according to the aspect of the present disclosure is suitable to perform the ammonia production method according to the aspect of the disclosure.

### BRIEF DESCRIPTION OF DRAWINGS

FIG. 1 is a sectional view illustrating an ammonia production apparatus 10; and

FIG. 2 is an explanatory view illustrating a cathode tank 27 and its peripheral devices.

### DESCRIPTION OF EMBODIMENTS

The following describes preferred embodiments of the ammonia production method and the ammonia production apparatus of the disclosure.

The ammonia production method according to an embodiment is a method of producing ammonia from nitrogen molecule using electron supplied from a power supply in the presence of a complex and a proton source. This method uses, as a catalyst, (A) a molybdenum complex having 2,6-bis(dialkylphosphinomethyl)pyridine (where two alkyl groups may be identical with each other or different from each other; and at least one hydrogen atom on a pyridine ring may be substituted with an alkyl group, an alkoxy group or a halogen atom), as a PNP ligand; (B) a molybdenum complex having 1,3-bis(dialkylphosphinomethyl)benzoimidazol-2-ylidene(where two alkyl groups may be identical with each other or different from each other; and at least one hydrogen atom on a benzene ring may be substituted with an alkyl group, an alkoxy group or a halogen atom), as a PCP ligand; (C) a molybdenum complex having bis(dialkylphosphinoethyl)arylphosphine (where two alkyl groups may be identical with each other or different from each other) as a PPP ligand; or (D) a molybdenum complex expressed as trans-Mo (N₂)₂ (R⁵R⁶R⁷P)₄ (where R⁵ and R⁶ represent aryl groups that may be identical with each other or different from each other; R⁷ represents an alkyl group; and two R⁷ groups may be connected with each other to form an alkylene chain).

In the molybdenum complex (A), the alkyl group may be a linear or branched alkyl group, such as methyl group, ethyl group, propyl group, butyl group, pentyl group, hexyl group and structural isomers thereof; or a cyclic alkyl group, such as cyclopropyl group, cyclobutyl group, cyclopentyl group and cyclohexyl group. The alkyl group preferably has one to twelve carbon atoms or more preferably has one to six carbon atoms. The alkoxy group may be a linear or branched alkoxy group, such as methoxy group, ethoxy group, propoxy group, butoxy group, pentoxy group, hexyloxy group, benzyloxy group and structural isomers thereof; or a cyclic alkoxy group, such as cyclopropoxy group, cyclobutoxy group, cyclopentoxy group and cyclohexyloxy group. The alkoxy group preferably has one to twelve carbon atoms. When the alkoxy group is benzyloxy group, at least one hydrogen atom on the benzene ring in the benzyloxy group may be substituted with a resin. The halogen atom is, for example, a fluorine atom, a chlorine atom, a bromine atom or an iodine atom.

The molybdenum complex (A) is, for example, a molybdenum complex expressed by a formula (A1), a formula (A2) or a formula (A3):

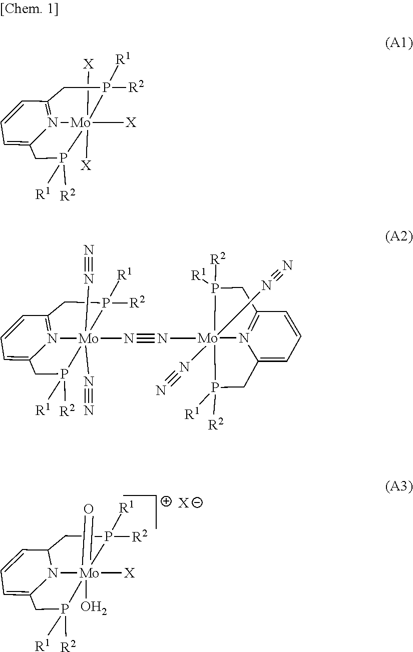

(where R¹ and R² represent alkyl groups that may be identical with each other or different from each other; X represents an iodine atom, a bromine atom, or a chlorine atom; and at least one hydrogen atom on a pyridine ring may be substituted with an alkyl group, an alkoxy group or a halogen atom). Examples of the alkyl group, the alkoxy group and the halogen atom are those described above. R¹ and R² are preferably bulky alkyl groups (for example, tert-butyl group or isopropyl group). It is preferable that the hydrogen atom on the pyridine ring is not substituted or that 4-position hydrogen atom on the pyridine ring is substituted with a chain, cyclic or branched alkyl group or alkoxy group having one to twelve carbon atoms. A more preferable example of the alkoxy group is benzyloxy group having at least one hydrogen atom on the benzene ring is substituted with a resin. Examples of the resin include chloromethyl resins (for example, polymer-bound [5-[4-(chloromethyl)phenyl]pentyl]styrene, polymer-bound 4-(benzyloxy)benzyl chloride, and polymer-bound 4-methoxybenzhydryl chloride), (chloromethyl) polystyrene, Merrifield resin, and JandaJel (trademark)-Cl. Among them, (chloromethyl) polystyrene, Merrifield resin, and JandaJel (trademark)-Cl are preferable.

The molybdenum complex (B) is, for example, a molybdenum complex expressed by a formula (B1) or a formula (B2):

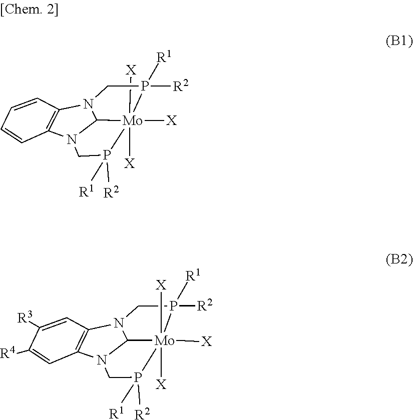

(where R¹ and R² represent alkyl groups that may be identical with each other or different from each other; X represents an iodine atom, a bromine atom, or a chlorine atom; and at least one hydrogen atom on a benzene ring may be substituted with an alkyl group, an alkoxy group or a halogen atom). Examples of the alkyl group, the alkoxy group and the halogen atom are those described above. R¹ and R² are preferably bulky alkyl groups (for example, tert-butyl group or isopropyl group). It is preferable that the hydrogen atom on the benzene ring is not substituted or that 5-position and 6-position hydrogen atoms on the benzene ring are substituted with a chain, cyclic or branched alkyl group having one to twelve carbon atoms. It is preferable that at least one of R³ and R⁴ is substituted with a trifluoromethyl group. It is more preferable that both R³ and R⁴ are substituted with a trifluoromethyl group.

The molybdenum complex (C) is, for example, a molybdenum complex expressed by a formula (C1):

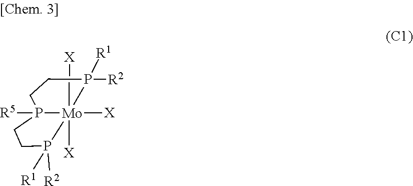

(where R¹ and R² represent alkyl groups that may be identical with each other or different from each other; R⁵ represents an aryl group; and X represents an iodine atom, a bromine atom, or a chlorine atom). Examples of the alkyl group are those described above. Examples of the aryl group include phenyl group, tolyl group, xylyl group, naphthyl group, and substituents thereof having at least one of hydrogen atoms on the ring substituted with an alkyl group or a halogen atom. Examples of the alkyl group and the halogen atom are those described above. R¹ and R² are preferably bulky alkyl groups (for example, tert-butyl group or isopropyl group). A preferable example of R⁵ is phenyl group.

The molybdenum complex (D) is, for example, a molybdenum complex expressed by a formula (D1) or a formula (D2):

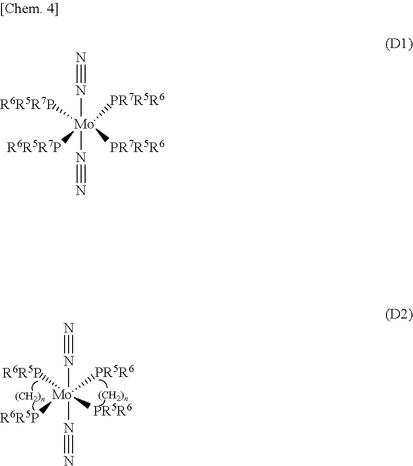

(where R⁵ and R⁶ represent aryl groups that may be identical with each other or different from each other; R⁷ represents an alkyl group; and n is equal to 2 or 3). Examples of the alkyl group and the aryl group are those described above. In the formula (D1), it is preferable that R⁵ and R⁶ are aryl groups (for example, phenyl group) and that R⁷ is an alkyl group having one to four carbon atoms (for example, methyl group). In the formula (D2), it is preferable that R⁵ and R⁶ are aryl groups (for example, phenyl group) and that n is equal to 2.

In the ammonia production method according to the embodiment, the ion exchange membrane used as the proton source is preferably a proton-conductive polymer electrolyte membrane. Available examples of the polymer electrolyte membrane include NEOSEPTA (registered trademark) by ASTOM Corporation, SELEMION (registered trademark) by AGC Inc., Aciplex (registered trademark) by Asahi Kasei Corporation, Fumasep (registered trademark) by Fumatech GmbH, fumapem (registered trademark) by Fumatech GmbH, Nafion (registered trademark) by DuPont, Aquivion (registered trademark) by Solvay S. A., FLEMION (registered trademark) by AGC Inc., and Gore-Tex (registered trademark) by Gore & Associates. For the ion exchange membrane 22, Aciplex (registered trademark) by Asahi Kasei Corporation, Nafion (registered trademark) by DuPont, Aquivion (registered trademark) by Solvay S. A., and FLEMION (registered trademark) by AGC Inc. are preferable, and Nafion (registered trademark) is more preferable.

In the ammonia production method according to the embodiment, it is preferable to use nitrogen gas as the nitrogen molecule. It is more preferable to use the nitrogen gas with controlling its flow rate by using a nitrogen gas cylinder, a regulator and a mass flow controller.

In the ammonia production method according to the embodiment, the reaction temperature is preferably ordinary temperature (0 to 40° C.). A pressurized atmosphere is not needed but a normal atmosphere is sufficient as the reaction atmosphere. The reaction time is not specifically limited but is generally set in a range of several minutes to several tens of hours.

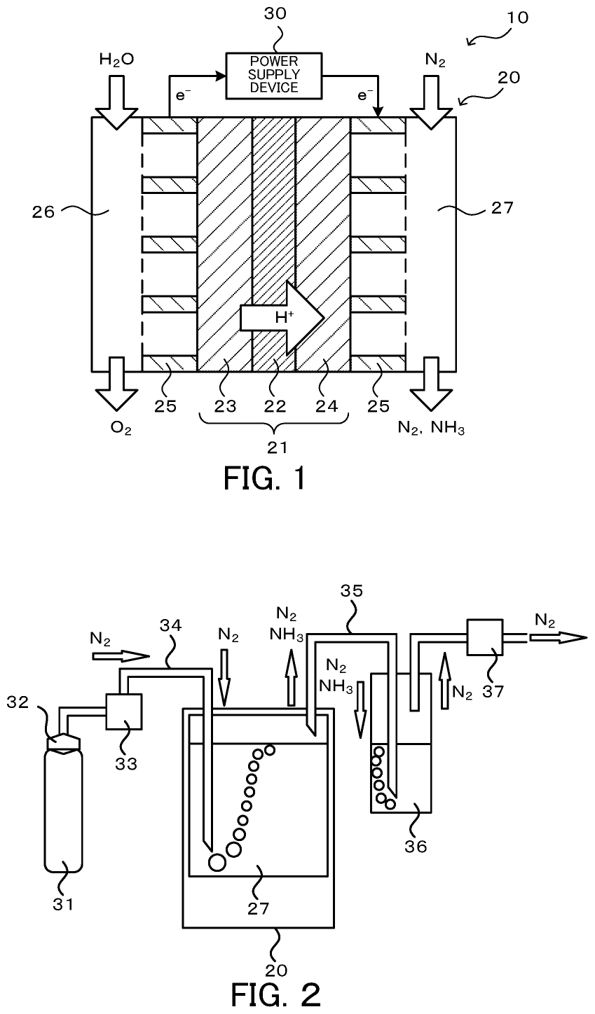

The following describes an ammonia production apparatus configured to perform the ammonia production method according to the embodiment. An ammonia production apparatus 10 is illustrated as one example. FIG. 1 is a sectional view illustrating the ammonia production apparatus 10. FIG. 2 is an explanatory view illustrating a cathode tank 27 and its peripheral devices.

The ammonia production apparatus 10 includes an apparatus main body 20 and a power supply device 30. The apparatus main body 20 includes a membrane electrode assembly 21, a pair of current collectors 25, 25, an anode tank 26, and a cathode tank 27. The power supply device 30 is placed outside of the apparatus main body 20 and is connected with an anode 23 and a cathode 24 in the apparatus main body 20.

The membrane electrode assembly 21 is configured such that respective faces of an ion exchange membrane 22 are placed between the anode 23 and the cathode 24. According to the embodiment, the anode 23 denotes an electrode into which the electric current flows from the power supply device 30, and the cathode 24 denotes an electrode from which the electric current flows out to the power supply device 30.

Electrochemically, the anode 23 denotes an electrode where an oxidation reaction occurs, and the cathode 24 denotes an electrode where a reduction reaction occurs. Production of ammonia is performed in the cathode tank 27 on the cathode 24-side.

The ion exchange membrane 22 is a member used as a proton source in the process of producing ammonia and is preferably a proton-conductive polymer electrolyte membrane. Concrete examples of this polymer electrolyte membrane are those described above.

The anode 23 includes a gas diffusion layer and a catalyst layer, although not being illustrated. The gas diffusion layer is placed on a current collector 25-side of the anode 23.

The gas diffusion layer used according to the embodiment is, for example, carbon paper, carbon cloth or carbon felt. Examples of the carbon paper include TGP-H-060, TGP-H-090, TGP-H-120, TGP-H-060H, TGP-H-090H and TGP-H-120H by Toray Industries, Inc.; EC-TP1-030T, EC-TP1-060T, EC-TP1-090T, and EC-TP1-120T by Electrochem, Inc.; and 22BB, 28BC, 36BB, and 39BB by SIGRACET. Examples of the carbon cloth include EC-CC1-060, EC-CC1-060T, and EC-CCC-060 by Electrochem, Inc.; and Torayca (registered trademark) cloth CO6142, CO6151B, CO6343, CO6343B, CO6347B, CO6644B, CO1302, CO1303, CO5642, CO7354, CO7359B, CK6244C, CK6273C and CK6261C by Toray Industries, Inc. Examples of the carbon felt include H1410 and H2415 by Freudenberg Group.

The gas diffusion layer in the anode 23 according to the embodiment is preferably carbon paper and is more preferably TGP-H-060, TGP-H-090, TGP-H-060H, TGP-H-090H, EC-TP1-060T, and EC-TP1-090T.

The catalyst layer in the anode 23 is a layer including a catalyst and is placed on an ion exchange membrane 22-side of the anode 23. The catalyst used may be any known catalyst without limitation as long as the catalyst serves to accelerate a reaction of producing proton from water. Examples of the catalyst include iridium (IV) oxide powdered catalyst, metals such as platinum, gold, silver, ruthenium, iridium, rhodium, palladium, osmium, tungsten, lead, iron, chromium, cobalt, nickel, manganese, vanadium, molybdenum, gallium, and aluminum and alloys thereof. Among them, iridium (IV) oxide powdered catalyst and platinum are preferable as the catalyst. The catalyst layer includes a catalyst support and an electrolyte other than the catalyst.

The catalyst support serves to support the catalyst. Examples of the catalyst support include carbon blacks such as channel black, furnace black, thermal black, acetylene black and Ketjen black; active carbons produced by carbonizing a variety of carbon atom-containing materials and activating the carbonized materials; carbonaceous materials such as cokes, natural graphite, artificial graphite, and graphitized carbon; metal meshes of nickel, titanium or the like; and metal foams. Among them, carbon black, Ketjen black, nickel metal mesh, titanium metal mesh, and metal foams are preferable, because of their high specific surface area and excellent electron conductivity. Titanium metal mesh and metal foams are more preferable, because of their excellent durability.

The electrolyte serves to perform proton conduction in the catalyst layer. Examples of the electrolyte include fluorinated sulfonic acid polymers such as Nafion (registered trademark) by DuPont, Aquivion (registered trademark) by Solvay S. A., FLEMION (registered trademark) by AGC Inc., and Aciplex (registered trademark) by Asahi Kasei Corporation, hydrocarbon-based sulfonic acid polymers, and partially fluorinated hydrocarbon-based sulfonic acid polymers. Nafion, Aquivion, FLEMION and Aciplex are preferable as the electrolyte. These electrolytes may be mixed in use. The electrolyte preferably includes perfluoro acid polymers such as Nafion from the viewpoint of the voltage characteristic in a high current range.

The cathode 24 includes a gas diffusion layer and a catalyst layer, although not being illustrated. The gas diffusion layer is placed on a current collector 25-side of the cathode 24. Concrete examples of this gas diffusion layer are those described above.

The gas diffusion layer in the cathode 24 according to the embodiment is preferably carbon paper, is more preferably TGP-H-060, TGP-H-090, TGP-H-060H, TGP-H-090H, EC-TP1-060T and EC-TP1-090T, and is furthermore preferably TGP-H-060H, TGP-H-090H, EC-TP1-060T and EC-TP1-090T.

The catalyst layer in the cathode 24 is a layer including a catalyst and is placed on an ion exchange membrane 22-side of the cathode 24. The catalyst is those serving to accelerate a reaction of producing ammonia from nitrogen, proton and electron, and concrete examples are any of the molybdenum complexes (A) to (D) described above. The molybdenum complex (A) is, for example, the molybdenum complex expressed by (A1), (A2) or (A3) described above. The molybdenum complex (B) is, for example, the molybdenum complex expressed by (B1) or (B2) described above. The molybdenum complex (C) is, for example, the molybdenum complex expressed by (C1) described above. The molybdenum complex (D) is, for example, the molybdenum complex expressed by (D1) or (D2) described above. The catalyst layer includes a catalyst support and an electrolyte other than the catalyst. The catalyst support and the electrolyte used are similar to those described above with regard to the anode 23.

The anode tank 26 is a tank placed on the anode 23-side, and the cathode tank 27 is a tank placed on the cathode 24-side.

Examples of a solution used in the tank according to the embodiment include water, ionic liquids, methanol, isopropyl alcohol, N,N-dimethylformamide, N,N-dimethylacetamide, dimethylsulfoxide, N-methylpyrrolidone, diethylamine, hexamethylphosphoric triamide, acetic acid, acetonitrile, methylene chloride, trifluoroethanol, nitromethane, sulfolane, pyridine, tetrahydrofuran, dimethoxyethane, and propylene carbonate. Among them, water, ionic liquids, tetrahydrofuran and dimethoxyethane are preferable.

More specifically, a supporting electrolyte may be added to the water as the solution used in the tank according to the embodiment. The supporting electrolyte is not specifically limited as long as the supporting electrolyte is a compound that is dissociated in water to form ions. Examples of the supporting electrolyte include HCl, HNO₃, H₂SO₄, HClO₄, NaCl, Na₂SO₄, NaClO₄, KCl, K₂SO₄, KClO₄, NaOH, LiOH, KOH, alkylammonium salts, alkylimidazolium salts, alkylpiperidinium salts, and alkylpyrrolidinium salts. One of these supporting electrolytes may be used alone, or two or more of these supporting electrolytes may be used in combination. Among them, water, purified water and a sulfuric acid aqueous solution (water containing H₂SO₄) are preferable as the solution used in the tank according to the embodiment.

Examples of the ionic liquid used in the tank according to the embodiment include diethyl-methyl-(2-methoxyethyl)ammonium-bis(trifluoromethan esulfonyl)imide, diethyl-methyl-(2-methoxyethyl)ammonium-tetrafluoroborate, N-methyl-N-propylpiperidinium-bis(trifluoromethanesulfonyl) imide, trimethyl-propylammonium-bis(trifluoromethanesulfonyl)imide, methyl-propylpyrrolidinium-bis(trifluoromethanesulfonyl)imi de, butyl-methylpyrrolidinium-bis(trifluoromethanesulfonyl)imid e, butylpyridinium-tetrafluoroborate, butylpyridinium-trifluoromethanesulfonate, 1-ethylpyridinium-hexafluoroborate, 1-methyl-1-propylpiperidinium-hexafluorophosphate, 1-butyl-1-methylpyrrolidinium-bis(trifluoromethanesulfonyl) imide, 1-butyl-3-methylimidazolium-tris(pentafluoroethyl)trifluoro phosphate, 1-butyl-1-methylpyrrolidinium-tris(pentafluoroethyl)trifluo rophosphate, and combinations thereof. One of these ionic liquids may be used alone or two or more of these ionic liquids may be used in combination. Among them, 1-butyl-1-methylpyrrolidinium-bis(trifluoromethanesulfonyl) imide and 1-butyl-3-methylimidazolium-tris(pentafluoroethyl)trifluoro phosphate are preferable.

An acid, such as sulfuric acid or trifluoromethanesulfonic acid, may be added to the ionic liquid in use. Preferable examples of the ionic liquid used with addition of the acid include 1-butyl-3-methylimidazolium-bis(trifluoromethanesulfonyl)im ide, 1-butyl-1-methylpiperidinium-bis(trifluoromethanesulfonyl)imide, and 1-butyl-3-methylimidazolium-tris(pentafluoroethyl)trifluoro phosphate.

The electrolyte included in the solution used in the tank according to the embodiment may be any substance that is dissolved in the solution to have ion conductivity. The electrolyte may be one cation used alone or a plurality of cations used in combination: for example, proton, lithium ion, sodium ion, potassium ion, imidazolium ion, pyridinium iron, quaternary ammonium ion, phosphonium ion, pyrrolidinium ion, and phosphonium ion or may be, on the other hand, one anion used alone or a plurality of anions used in combination: for example, chlorine ion, bromine ion, iodine ion, tetrafluoroborate, trifluoro(trifluoromethyl) borate, dimethylphosphate ion, diethylphosphate ion, hexafluorophosphate, tris(pentafluoroethyl)trifluorophosphate, trifluoroacetate, methylsulfate, trifluoromethanesulfonate, bis(trifluoromethanesulfonyl)imide, perchlorate ion, sulfate ion, and nitrate ion. One of these electrolytes may be used alone, or two or more of these electrolytes may be used in combination.

Examples of the imidazolium ion of the electrolyte include 1-allyl-3-methylimidazolium ion, 1-butyl-3-methylimidazolium ion, 1-butyl-2,3-dimethylimidazolium ion, 1-butyl-3-methylimidazolium ion, 1-butyl-2,3-dimethylimidazoium ion, 1-butyl-3-methylimidazolium ion, 1,3-dimethylimidazolium ion, 2,3-dimethyl-1-propylimidazolium ion, 1-decyl-3-methylimidazolium ion, 1,3-dimethylimidazolium ion, 1-decyl-3-methylimidazolium ion, 1-ethyl-3-methylimidazolium ion, 1-ethyl-2,3-dimethylimidazolium ion, 1-ethyl-3-methylimidazolium ion, 3-ethyl-1-vinylimidazolium ion, 1-ethyl-3-methylimidazolium ion, 1-hexyl-3-methylimidazolium ion, 1-(2-hydroxyethyl)-3-methylimidazolium ion, 1-hexyl-3-methylimidazolium ion, 1-(2-hydroxyethyl)-3-methylimidazolium ion, 1-hexyl-3-methylimidazolium ion, 1-methyl-3-propylimidazolium ion, 1-methyl-3-n-octylimidazolium ion, 1-methyl-3-propylimidazolium ion, 1-methyl-3-pentylimidazolium ion, 1-methyl-3-n-octylimidazolium ion, and 1-methyl-3-propylimidazolium ion.

Examples of the pyridinium ion of the electrolyte include 1-butylpyridinium ion, 1-butyl-4-methylpyridinium ion, 1-ethyl-3-methylpyridinium ion, and 1-ethyl-3-(hydroxymethyl)pyridinium ion.

Examples of the quaternary ammonium ion of the electrolyte include triethylpentylammonium ion, diethyl(methyl)propylammonium ion, methyltri-n-octylammonium ion, trimethypropylammonium ion, cyclohexyltrimethylammonium ion, diethyl(2-methoxyethyl)methylammonium ion, ethyl(2-methoxyethyl)-dimethylammonium ion, ethyl(3-methoxypropyl)dimethylammonium ion, ethyl(dimethyl) (2-phenylethyl)ammonium ion, tetramethylammonium ion, tetraethylammonium ion, triethylpentylammonium ion, tetra-n-butylammonium ion, diethyl(methyl)propylammonium ion, methyltri-n-octylammonium ion, trimethylpropylammonium ion, cyclohexyltrimethylammonium ion, diethyl(2-methoxyethyl)methylammonium ion, ethyl(2-methoxyethyl)dimethylammonium ion, ethyl(3-methoxypropyl)dimethylammonium ion and ethyl(dimethyl) (2-phenylethyl) ammonium ion.

Examples of the phosphonium ion of the electrolyte include tributylmethylphosphonium ion and tributylethylphosphonium ion.

Examples of the pyrrolidinium ion of the electrolyte include 1-allyl-1-methylpyrrolidinium ion, 1-butyl-1-methylpyrrolidinium ion, 1-methyl-1-propylpyrrolidinium ion, and 1-(2-methoxyethyl)-1-methylpyrrolidinium ion.

Water, purified water and a sulfuric acid aqueous solution (water containing H₂SO₄) are preferable as the solution used in the anode tank 26. The ionic liquid, water and a sulfuric acid aqueous solution (water containing H₂SO₄) are preferable as the solution used in the cathode tank 27. Among them,

1-butyl-3-methylimidazolium-tris(pentafluoroethyl)trifluoro phosphate,
1-butyl-1-methylpyrrolidinium-bis(trifluoromethanesulfonyl) imide, and the sulfuric acid aqueous solution (water containing H₂SO₄) are more preferable.

In the anode tank 26, in the case where the solution and the electrolyte used in the tank are non-aqueous, the embodiment may be implemented with addition of water. Oxygen, proton and electron are produced from the water used in the anode tank 26 by the action of the catalyst of the anode 23 (2H₂O→O₂+4e⁻+4H⁺). The proton moves through the ion exchange membrane 22 to the cathode 24, and the electron moves through the cathode 24-side current collector 25 to the power supply device 30. The produced oxygen is releasable to the atmosphere, while being partly dissolved in the solution in the anode tank 26. The oxygen may also be forcibly released out by bubbling the solution in the anode tank 26 with nitrogen gas.

Nitrogen gas is supplied to the cathode tank 27. As shown in FIG. 2, the supply of nitrogen gas is carried out by controlling the flow rate of nitrogen gas supplied from a nitrogen gas cylinder 31 by a regulator 32 and a mass flow controller 33 and bubbling nitrogen gas through a gas piping 34 in the solution in the anode tank 26. In the cathode 24, a reaction of the nitrogen gas supplied to the cathode tank 27, the proton moved from the anode 23 across the ion exchange membrane 22 or the proton derived from the solution used in the cathode tank 27, and the electron supplied from the power supply device 30 occurs in the presence of the molybdenum complex described above to produce ammonia (N₂+6e⁻+6H⁺→2NH₃). A gaseous mixture comprised of the ammonia produced in the cathode 24, hydrogen produced as a by-product and unreacted nitrogen is sent from the cathode tank 27 through a gas piping 35 to a diluted sulfuric acid aqueous solution tank 36 for ammonia trapping. The ammonia trapping may be implemented: by trapping ammonia by the diluted sulfuric acid aqueous solution when the gaseous mixture passes through this diluted sulfuric acid aqueous solution tank 36; by trapping ammonia by the solution used in the cathode tank 27 or by trapping ammonia by both these solutions described above. The hydrogen as the by-product and the nitrogen are safely discharged to the outside via a drafting machine 37. Putty or a sealing agent is used at joints of the gas pipings 34 and 35 with the cathode tank 27 to prevent a gas leakage.

The present disclosure is not limited to the embodiments described above but may be implemented by a variety of other embodiments as long as they fall into the technical scope of the present disclosure.

### EXAMPLES

The following describes examples of the present disclosure. The present disclosure is, however, not limited to the examples described below.

### Example of Experiment 1

### 1. Manufacture of Ammonia Production Apparatus 10

The anode 23 was produced first as described below. A catalyst ink used for the anode 23 was prepared by using platinum-supported carbon (trade name “TEC10E50E” manufactured by Tanaka Kikinzoku Kogyo K. K.; platinum content: 46.5% by weight), deionized water, ethanol (manufactured by FUJIFILM Wako Pure Chemical Corporation); and a Nafion dispersion solution serving as the electrolyte (trade name “5% Nafion Dispersion Solution DE521 CS type” manufactured by FUJIFILM Wako Pure Chemical Corporation). The catalyst ink was prepared by adding the platinum-supported carbon, the deionized water, the ethanol, and the Nafion dispersion solution in this sequence to a glass vial and irradiating the resulting dispersion solution for 30 minutes with ultrasonic wave set to a 40% output by using an ultrasonic homogenizer Smurt NR-50M manufactured by MICROTEC CO., LTD. This catalyst ink was subsequently applied on a carbon paper (trade name “TGP-H-090H” manufactured by Toray Industries, Inc.; a square of 2.9 cm×2.9 cm) fixed on a hot plate set to 80° C. The amount of application was determined such that the amount of platinum per 1 cm² of the coating surface was 2.4 mg. This produced the anode 23 including the platinum catalyst (20 mg).

The following explains the rate of Nafion serving as a proton-conductive ionomer (hereinafter abbreviated as the ionomer) in the catalyst ink described above. The catalyst ink was prepared, such that the rate of the ionomer (% by weight) calculated from an equation given below was equal to 28% by weight:

Rate of Ionomer (% by weight)=[solid content(weight) of ionomer/[{platinum-supported carbon(weight)+solid content(weight) of ionomer}]×100.

More specifically, in the case where the ionomer was Nafion, the amount of the platinum-supported carbon was set to 100.0 mg, the amount of the Nafion dispersion solution was set to 837 μL, the amount of deionized water was set to 0.6 mL, and the amount of ethanol was set to 5 mL. The Nafion solid content in the Nafion dispersion solution (837 μL) was 38.9 mg.

The cathode 24 was subsequently produced as described below. Prior to production of the cathode 24, a composition of Ketjen black and Nafion (hereinafter referred to as Composition 1) was produced as described below. Ketjen black (535 mg, trade name “EC600JD” manufactured by Lion Specialty Chemicals Co., Ltd.) and a Nafion dispersion solution (8.37 mL, trade name “5% Nafion Dispersion Solution DE521 CS type” manufactured by FUJIFILM Wako Pure Chemical Corporation) were mixed in a screw tube. The resulting dispersion solution was irradiated for 30 minutes with ultrasonic wave set to a 40% output by using the ultrasonic homogenizer Smurt NR-50M manufactured by MICROTEC CO., LTD. Ethanol as the solvent of the Nafion dispersion solution was subsequently removed by using an evaporator. Accordingly, 919 mg (99% yield) of black powdery Composition 1 of Ketjen black and Nafion was obtained.

The catalyst ink used for the cathode was prepared by grinding Molybdenum complex (1) (9.1 mg, molar number of molybdenum: 6.6 μmol measured by ICP emission spectrochemical analysis) supported on Merrifield resin and expressed by a formula given below and Composition 1 (51.8 mg) in a mortar to obtain a mixture of the molybdenum complex supported on the resin, Ketjen black and Nafion and dispersing the mixture in an ionic liquid (1-butyl-1-methylpyrrolidinium-bis(trifluoromethanesulfonyl) imide, 300 μL). The resulting dispersion was applied on a carbon paper (trade name “TGP-H-090H” manufactured by Toray Industries, Inc.; a square of 2.9 cm×2.9 cm). This produced the cathode 24. The molybdenum complex (1) may be synthesized by a method described in Non-Patent Literature: Chem. Lett. 2019, Vol. 48, pp. 693-695.

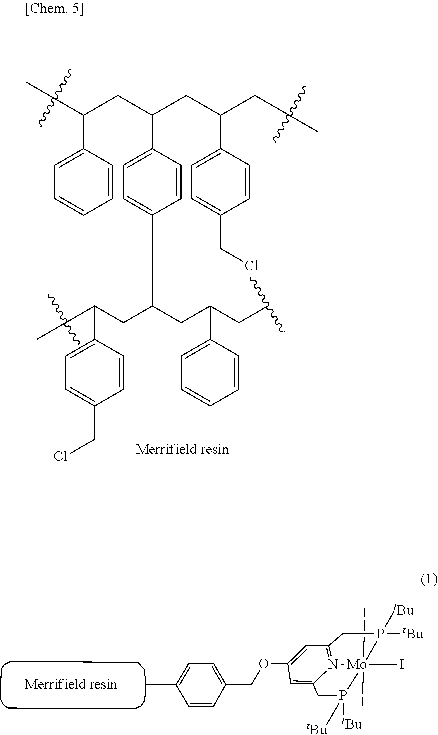

The membrane electrode assembly 21 was subsequently manufactured as described below. A Nafion (registered trademark) 212 membrane by DuPont (membrane thickness of 50 μm, a square of 5 cm×4 cm) was provided as the ion exchange membrane 22. The membrane electrode assembly 21 was obtained by placing the anode 23 on one surface of the ion exchange membrane 22 and placing the cathode 24 on the other surface of the ion exchange membrane 22. The anode 23 and the cathode 24 were arranged such that respective catalyst-coating surfaces thereof were in contact with the ion exchange membrane 22.

The current collectors 25, 25 made of stainless steel and perforated to have twenty-five circular holes of 2.5 mm in diameter were attached to the respective surfaces of the membrane electrode assembly 21 thus obtained. The anode tank 26 was then attached to the anode-side current collector 25 via a Teflon (registered trademark) gasket, and the cathode tank 27 was attached to the cathode-side current collector 25 via a Teflon gasket. The power supply device 30 was connected with both the current collectors 25, 25. The ammonia production apparatus 10 was accordingly constructed.

### 2. Production of Ammonia

Ammonia was produced under the following conditions by using the ammonia production apparatus 10 constructed as described above.

Temperature of the apparatus main body 20: 25 to 28° C. (ambient temperature)

Power supply device 30: Versa STAT 4 manufactured by Princeton Applied Research, Inc., was used, and the voltage and the electric current were measured.

Anode Tank 26: Purified Water (8 mL)

Cathode tank 27: (1-butyl-1-methylpyrrolidinium-bis(trifluoromethanesulfonyl) imide (8 mL)

Measurement condition: constant potential measurement was performed at −2.3 V for 50 minutes.

Thermo Scientific Dionex ion chromatography (IC) system, Dionex Integrion, manufactured by Thermo, Inc., was used for quantification of ammonia. The amounts of ammonia were determined in water of the diluted sulfuric acid aqueous solution tank for ammonia trapping and in the ionic liquid of the cathode tank. With a view to relieving the load of a column and a suppressor of the apparatus, ammonia in the ionic liquid was once extracted in an aqueous phase by using purified water to be analyzed.

The results are shown in Table 1. In Example of Experiment 1, the amount of ammonia produced was 0.703 μmol, the quantity of electricity used was 64.6 C, and the conversion efficiency was 0.32%. The amount of ammonia produced per 1 μmol of the complex was 106.5 nmol.

### Example of Experiment 2

The ammonia production apparatus 10 was manufactured in a similar manner to that of Example of Experiment 1 described above, except that the catalyst added to the cathode 24 was changed from the molybdenum complex to titanocene dichloride. More specifically, the cathode 24 was produced as follows. Titanocene dichloride (46.5 mg) and Composition 1 (92.4 mg) described above were ground in a mortar to obtain a mixture of the complex, Ketjen black and Nafion. The cathode 24 was then obtained by applying a dispersion of the mixture (39 mg) and an ionic liquid (1-butyl-1-methylpyrrolidinium-bis(trifluoromethanesulfonyl) imide, 300 μL) on the carbon paper.

Production of ammonia was tried in a similar manner to that of Example of Experiment 1 by using this ammonia production apparatus 10. The results are shown in Table 1. In Example of Experiment 2, the amount of ammonia produced was 0.523 μmol, the quantity of electricity used was 81.3 C, and the conversion efficiency was 0.19%. The amount of ammonia produced per 1 μmol of the complex was 9.9 nmol.

### Example of Experiment 3

The ammonia production apparatus 10 was manufactured in a similar manner to that of Example of Experiment 1 described above, except that no catalyst was added to the cathode 24. Production of ammonia was tried in a similar manner to that of Example of Experiment 1 by using this ammonia production apparatus 10. The results are shown in Table 1. In Example of Experiment 3, the amount of ammonia produced was 0.121 μmol. Ammonia derived from members of the ammonia production apparatus 10 was detected.

### DISCUSSION

Example of Experiment 1 using the molybdenum complex as the catalyst of the cathode produced ten or more times the amount of ammonia produced in Example of Experiment 2 using titanocene dichloride as the catalyst of the cathode. Substantially no ammonia was produced in Example of Experiment 3 without addition of the catalyst to the cathode. Example of Experiment 1 corresponds to the example of the present disclosure, and Examples of Experiments 2 and 3 correspond to comparative examples.

TABLE 1

| | | Example 1 | Example 2 | Example 3 |
|---|---|---|---|---|
| Catalyst | Type | Mo | Cp₂TiCl₂ | Not used |
| | | Complex (1) | | |
| | Amount Used | 6.6 | 53 | |
| | (μmol) | | | |

| | | | |
|---|---|---|---|
| Amount of Ammonia Produced (μmol) | 0.703 | 0.523 | 0.121 |
| Conversion Efficiency (%) | 0.32 | 0.19 | — |
| Amount of Ammonia (nmol) | 106.5 | 9.9 | — |

Produced per 1 μmol of catalyst

### Example of Experiment 4

The ammonia production apparatus 10 was manufactured in a similar manner to that of Example of Experiment 1 described above, except that the catalyst added to the cathode 24 was changed to a molybdenum complex (2) and that the ionic liquid used in the cathode tank and in the catalyst layer was changed to 1-butyl-3-methylimidazolium-tris(pentafluoroethyl)trifluoro phosphate. More specifically, the cathode 24 was produced as follows. The molybdenum complex (2) (6.0 mg, 6.6 μmol) and Composition 1 (51.8 mg) described above were ground in a mortar to obtain a mixture of the complex, Ketjen black and Nafion. The cathode 24 was then obtained by applying a dispersion of the mixture and the ionic liquid (1-butyl-3-methylimidazolium-tris(pentafluoroethyl)trifluor ophosphate, 300 μL) on the carbon paper.

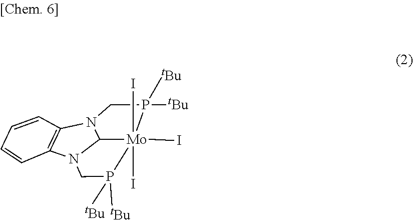

Production of ammonia was tried in a similar manner to that of Example of Experiment 1 by using this ammonia production apparatus 10. The results are shown in Table 2. In Example of Experiment 4, the amount of ammonia produced was 0.540 μmol, the quantity of electricity used was 103.6 C, and the conversion efficiency was 0.15%. The amount of ammonia produced per 1 μmol of the complex was 81.8 nmol.

### Example of Experiment 5

The ammonia production apparatus 10 was manufactured in a similar manner to that of Example of Experiment 4 described above, except that the catalyst added to the cathode 24 was changed to a molybdenum complex (3). More specifically, the molybdenum complex (3) (5.8 mg, 6.6 μmol) and Composition 1 (51.8 mg) described above were used.

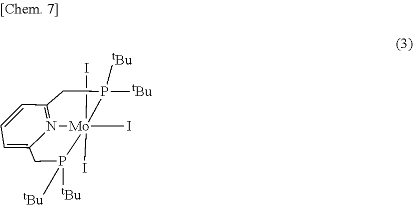

Production of ammonia was tried in a similar manner to that of Example of Experiment 1 by using this ammonia production apparatus 10. The results are shown in Table 2. In Example of Experiment 5, the amount of ammonia produced was 1.003 μmol, the quantity of electricity used was 114.1 C, and the conversion efficiency was 0.25%. The amount of ammonia produced per 1 μmol of the complex was 152.0 nmol. Example of Experiment 4 and Example of Experiment 5 correspond to the examples of the present disclosure.

TABLE 2

| | | Example 4 | Example 5 |
|---|---|---|---|
| Catalyst | Type | Mo | Mo |
| | | Complex (2) | Complex (3) |
| | Amount Used | 6.6 | 6.6 |
| | (μmol) | | |

| | | |
|---|---|---|
| Amount of Ammonia | 0.540 | 1.003 |
| Produced (μmol) | | |
| Conversion Efficiency (%) | 0.15 | 0.25 |
| Amount of Ammonia (nmol) | 81.8 | 152.0 |
| Produced per l μmol of | | |
| catalyst | | |

### Example of Experiment 6

### 1. Manufacture of Ammonia Production Apparatus 10

The anode 23 was produced as described below. The anode 23 of Example of Experiment 6 was produced by a process similar to the process of producing the anode 23 of Example of Experiment 1, except that the size of the carbon paper (trade name “TGP-H-090H” manufactured by Toray Industries, Inc.; a square of 2.7 cm×2.7 cm) and the amount of application were changed. The amount of application was determined, such that the amount of platinum per 1 cm² of the coating surface was 1.0 mg. More specifically, the anode 23 was the carbon paper with the platinum catalyst (7.3 mg) applied on one surface thereof.

The cathode 24 was produced as described below. A catalyst ink was prepared first by dissolving the molybdenum complex (3) (5.8 mg) described above in 1-butyl-1-methylpyrrolidinium-bis(trifluoromethanesulfonyl) imide (1.0 mL). The cathode 24 of Example of Experiment 6 was produced by applying this catalyst ink (50 μL) on a carbon paper (trade name “TGP-H-090H” manufactured by Toray Industries, Inc.; a square of 2.7 cm×2.7 cm). More specifically, the cathode 24 was the carbon paper with the molybdenum complex (0.29 mg, 0.33 μmol) expressed by Formula (3) and 1-butyl-1-methylpyrrolidinium-bis(trifluoromethanesulfonyl) imide (50 μL) as the ionic liquid applied on one surface thereof.

The membrane electrode assembly 21 was subsequently manufactured as described below. A Nafion 212 membrane by DuPont (membrane thickness of 50 μm, a square of 5 cm×4 cm) was provided as the ion exchange membrane 22. The membrane electrode assembly 21 of Example of Experiment 6 was obtained by placing the anode 23 produced as described above on one surface of the ion exchange membrane 22, placing the cathode 24 produced as described above on the other surface of the ion exchange membrane 22, and subsequently performing thermocompression bonding under the conditions of top-bottom plate temperature of 132° C., a load of 5.4 kN, and a pressure bonding time of 240 seconds. The anode 23 and the cathode 24 were arranged such that respective catalyst-coating surfaces thereof were in contact with the ion exchange membrane 22.

The current collectors 25, 25 made of stainless steel and perforated to have twenty-five circular holes of 2.5 mm in diameter were attached to the respective surfaces of the membrane electrode assembly 21 thus obtained. The anode tank 26 was then attached to the anode-side current collector 25 via a Teflon gasket, and the cathode tank 27 was attached to the cathode-side current collector 25 via a Teflon gasket. The power supply device 30 was connected with both the current collectors 25, 25. The ammonia production apparatus 10 of Example of Experiment 6 was accordingly constructed.

### 2. Production of Ammonia

Ammonia was produced under the following conditions by using the ammonia production apparatus 10 constructed as described above.

Temperature of the apparatus main body 20: 25 to 28° C. (ambient temperature)

Power supply device 30: Versa STAT 4 manufactured by Princeton Applied Research, Inc., was used, and the voltage and the electric current were measured.

Anode tank 26: a 0.02 mol/L sulfuric acid aqueous solution (6 mL)

Cathode tank 27: (1-butyl-1-methylpyrrolidinium-bis(trifluoromethanesulfonyl) imide (6 mL)

Measurement condition: constant potential measurement was performed at −2.3 V for 60 minutes.

Thermo Scientific Dionex ion chromatography (IC) system, Dionex Integrion, manufactured by Thermo, Inc., was used for quantification of ammonia. The amounts of ammonia were determined in water of the diluted sulfuric acid aqueous solution tank for ammonia trapping and in the ionic liquid of the cathode tank.

In Example of Experiment 6, the amount of ammonia produced was 0.390 μmol, the quantity of electricity used was 21.8 C, and the conversion efficiency was 0.52%. The amount of ammonia produced per 1 μmol of the complex was 1180 nmol. Compared with Example of Experiment 5 using the same molybdenum complex (3), the amount of ammonia produced per 1 μmol of the complex for 50 minutes was 983.3 nmol. This shows an improvement of approximately six times.

### Example of Experiment 7

The ammonia production apparatus 10 was manufactured in a similar manner to that of Example of Experiment 6 described above, except that the solution used for the catalyst ink in the process of producing the cathode 24 was changed to dichloromethane (1.0 mL) and that the solution used for the cathode tank 27 was changed to a 0.02 mol/L sulfuric acid aqueous solution (6 mL) and was used to produce ammonia. The amount of ammonia produced was 0.20 μmol, the quantity of electricity used was 105.1 C, and the conversion efficiency was 0.06%. The amount of ammonia produced per 1 μmol of the complex was 606.1 nmol. Compared with Example of Experiment 5 using the same molybdenum complex (3), the amount of ammonia produced per 1 μmol of the complex for 50 minutes was 505.1 nmol. This shows an improvement of approximately three times. Example of Experiment 6 and Example of Experiment 7 correspond to the examples of the present disclosure.

The present application claims priority to Japanese patent application No. 2019-162176 filed on Sep. 5, 2019, and the entire disclosure of this Japanese patent application is incorporated herein by reference in its entirety.

### INDUSTRIAL APPLICABILITY

The present disclosure is applicable to the ammonia production method.

1. An ammonia production method of producing ammonia from nitrogen molecule using electron supplied from a power supply in presence of a complex and a proton source,
wherein the complex is:
(A) a molybdenum complex having 2,6-bis(dialkylphosphinomethyl)pyridine (where two alkyl groups are identical with each other or are different from each other; and at least one hydrogen atom on a pyridine ring is substituted with or is not substituted with an alkyl group, an alkoxy group or a halogen atom), as a PNP ligand;
(B) a molybdenum complex having 1,3-bis(dialkylphosphinomethyl)benzoimidazol-2-ylidene(where two alkyl groups are identical with each other or are different from each other; and at least one hydrogen atom on a benzene ring is substituted with or is not substituted with an alkyl group, an alkoxy group or a halogen atom), as a PCP ligand;
(C) a molybdenum complex having bis(dialkylphosphinoethyl)arylphosphine (where two alkyl groups are identical with each other or are different from each other) as a PPP ligand; or
(D) a molybdenum complex expressed as trans-Mo(N₂)₂(R⁵R⁶R⁷P)₄ (where R⁵ and R⁶ represent aryl groups that are identical with each other or are different from each other; R⁷ represents an alkyl group; and two R⁷ groups are connected with each other to form an alkylene chain or are not connected with each other), and
the proton source used is an electrolyte membrane, a solution used in a cathode tank, or both the electrolyte membrane and the solution used in the cathode tank.

2. The ammonia production method according to claim 1,
wherein the molybdenum complex (A) is a molybdenum complex expressed by a formula (A1), a formula (A2) or a formula (A3): 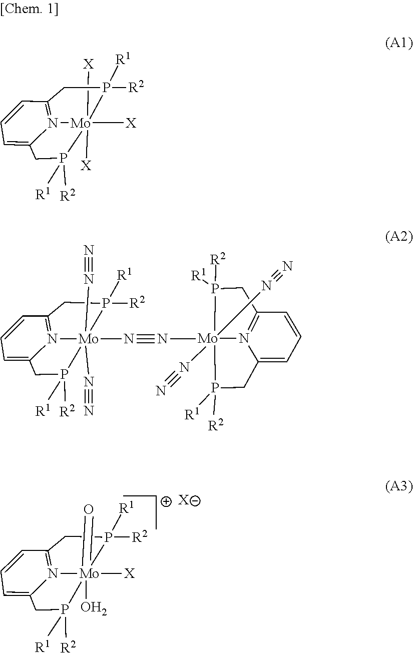
(where R¹ and R² represent alkyl groups that are identical with each other or are different from each other; X represents an iodine atom, a bromine atom, or a chlorine atom; and at least one hydrogen atom on a pyridine ring is substituted with or is not substituted with an alkyl group, an alkoxy group or a halogen atom).

3. The ammonia production method according to claim 1,
wherein the molybdenum complex (B) is a molybdenum complex expressed by a formula (B1) or a formula (B2): 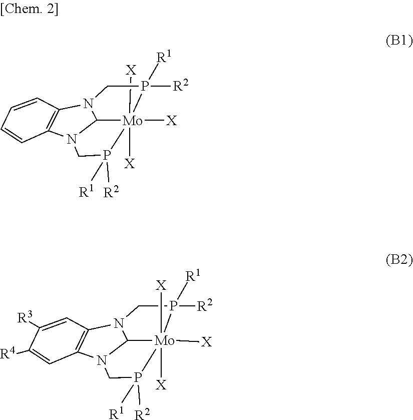
(where R¹ and R² represent alkyl groups that are identical with each other or are different from each other; X represents an iodine atom, a bromine atom, or a chlorine atom; at least one hydrogen atom on a benzene ring is substituted with or is not substituted with an alkyl group, an alkoxy group or a halogen atom; and at least one of R³ and R⁴ is substituted with a trifluoromethyl group).

4. The ammonia production method according to claim 1,
wherein the molybdenum complex (C) is a molybdenum complex expressed by a formula (C1): 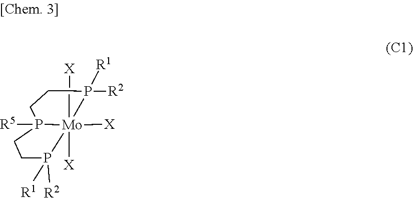
(where R¹ and R² represent alkyl groups that are identical with each other or are different from each other; R⁵ represents an aryl group; and X represents an iodine atom, a bromine atom, or a chlorine atom).

5. The ammonia production method according to claim 1,
wherein the molybdenum complex (D) is a molybdenum complex expressed by a formula (D1) or a formula (D2): 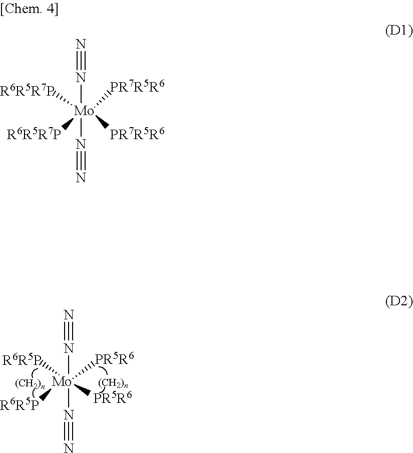
(where R⁵ and R⁶ represent aryl groups that are identical with each other or are different from each other; R⁷ represents an alkyl group; and n is equal to 2 or 3).

6. The ammonia production method according to claim 1,
wherein atmospheric nitrogen gas is used as the nitrogen molecule.

7. An ammonia production apparatus, comprising:
an apparatus main body comprising a membrane electrode assembly configured such that an ion exchange membrane is placed between a cathode and an anode; a pair of current collectors arranged to place the membrane electrode assembly therebetween; an anode tank placed on one current collector side that is in contact with the anode; a cathode tank placed on other current collector side that is in contact with the cathode; and a nitrogen gas supplier configured to supply nitrogen gas to the cathode tank; and
a power supply device placed outside of the apparatus main body and connected with the pair of current collectors, wherein
the cathode includes, as a catalyst,
(A) a molybdenum complex having 2,6-bis(dialkylphosphinomethyl)pyridine (where two alkyl groups are identical with each other or are different from each other; and at least one hydrogen atom on a pyridine ring is substituted with or is not substituted with an alkyl group, an alkoxy group or a halogen atom), as a PNP ligand;
(B) a molybdenum complex having 1,3-bis(dialkylphosphinomethyl)benzoimidazol-2-ylidene(where two alkyl groups are identical with each other or are different from each other; and at least one hydrogen atom on a benzene ring is substituted with or is not substituted with an alkyl group, an alkoxy group or a halogen atom), as a PCP ligand;
(C) a molybdenum complex having bis(dialkylphosphinoethyl)arylphosphine (where two alkyl groups are identical with each other or are different from each other) as a PPP ligand; or
(D) a molybdenum complex expressed as trans-Mo(N₂)₂(R⁵R⁶R⁷P)₄ (where R⁵ and R⁶ represent aryl groups that are identical with each other or are different from each other; R⁷ represents an alkyl group; and two R⁷ groups are connected with each other to form an alkylene chain or are not connected with each other), and
the anode includes a catalyst acting to produce proton from water.

8. The ammonia production apparatus according to claim 7,
wherein a solution used in the anode tank is water or a sulfuric acid aqueous solution (water containing H₂SO₄), and
a solution used in the cathode tank is water, a sulfuric acid aqueous solution (water containing H₂SO₄) or an ionic liquid.
